(19) United States
(12) Patent Application Publication
(10) Pub. No.: US 2008/0120998 A1
(43) Pub. Date: May 29, 2008

(54) Laundry Device

(75) Inventor: Chi Wan Hur, Gyeongsangnam-do (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 10/564,155

(22) PCT Filed: Dec. 7, 2005
(86) PCT No.: PCT/KR05/04166

§ 371 Date: Feb. 6, 2008

(30) Foreign Application Priority Data
Dec. 8, 2004 (KR) 10-2004-0102892
Jan. 25, 2005 (KR) 10-2005-0006659

(51) Int. Cl. D06F 39/12; H01R 13/639; H01R 13/74

(52) U.S. Cl. 68/212; 439/373; 439/544

(57) ABSTRACT

The present invention relates to a laundry device, and more particularly, to a laundry device of a new structure, in which a depressed portion is formed along a circumference of a portion of a hole in a cabinet for press fit to a groove in a holding member of a power cord assembly, thereby maintaining a secure joining state of the power cord assembly with the cabinet.

### TECHNICAL FIELD

The present invention relates to laundry devices, and more particularly, to a laundry device which enables secure joining of a power cord with a cabinet.

### BACKGROUND ART

In general, the laundry device includes apparatuses for washing clothes and beddings.

The laundry device includes a washing machine, a drying and washing machine, and a laundry dryer.

A related art laundry device will be described, briefly.

Referring to FIG. 1, the related art laundry device is provided with a cabinet 1 forming an exterior of the laundry device, a top cover 2 on top of the cabinet 1, a cabinet cover 3 on a front of the cabinet 1, and a power cord 7 for supplying power to the laundry device.

A structure for mounting the power cord 7 will be described in more detail with reference to FIGS. 2 and 3.

The power cord 7, passed through a rear wall 4 of the cabinet 1, is provided with a push-in portion 8, a sealing portion 10, and a groove 9, and electric wires 11, and 13.

The push-in portion 8 is pushed into the cabinet 1 through a hole 12 in the rear wall 4. the push-in portion 8 prevents the power cord from falling off the cabinet 1.

The hole 12 in the rear wall 4 is rectangular or elliptic having a width different from a height, and the push-in portion 8 has a shape in conformity with the hole 12.

Accordingly, after aligning the push-in portion with the hole, and pushing the push-in portion into the hole, if the push-in portion is turned at 90 substantially, falling off of the push-in portion from the hole is prevented.

The sealing portion 10 is brought into close contact with the rear wall 4 of the cabinet 1.

The sealing portion 10 prevents the power cord 7 from being pushed into the cabinet 1, excessively.

The groove 9 connects between the push-in portion 8 and the sealing portion 10, and is recessed relative to the push-in portion 8.

The rear wall 4 is placed in the groove 9.

However, the structure for placing the related art power cord 7 in the cabinet 1 has the following various problems.

Referring to FIG. 3, if a width of the groove 9 is greater than a thickness of the rear wall, the power cord 7 can not be fastened, securely.

That is, the power cord 7 is placed in the rear wall 4 not tightly, to cause falling off of the power cord 7, resulting in an accident caused by negligence of safety.

Moreover, it is recent trend that dimensions of portions of the power cord 7 are standardized gradually, in which the width of the groove 9 is greater than the thickness of the rear wall.

However, if the thickness of the rear wall 4 is increased similar to the width of the groove 9 for meeting the standard, a production cost and weight can not, but increases.

### DISCLOSURE OF INVENTION

### Technical Problem

An object of the present invention is to provide a laundry device in which a power cord thereof can maintain a state of securely fastened to the cabinet.

### Technical Solution

The object of the present invention can be achieved by providing a laundry device including a cabinet having a hole, a power cord assembly having electric wires, and a holding member at one ends of the electric wires with a groove at a circumferential surface for placing the cabinet therein, for passing through the hole, and securing to the cabinet, and a depressed portion at a portion of the cabinet where the groove is to be placed therein, for press fitting in the groove.

In another aspect of the present invention, a laundry device includes a cabinet having a hole, a power cord assembly having electric wires, and a holding member at one ends of the electric wires with a groove at a circumferential surface for placing the cabinet therein, for passing through the hole, and securing to the cabinet, and at least holding portion projected from a portion of the cabinet where the groove is to be placed therein to an inner or cuter side of the cabinet.

### Advantageous Effects

The laundry device of the present invention permits secure joining of a power cord regardless of a size of the power cord assembly by changing a structure of the cabinet.

Moreover, the laundry device of the present invention permits to prevent the power cord assembly from falling off owing to the power cord assembly press fit to a cabinet, thereby preventing accidents caused by negligence of safety from taking place in advance.

Furthermore, the laundry device of the present invention permits to prevent the power cord assembly from turning owning to holding portions of the cabinet to prevent the power cord assembly from falling off, thereby preventing accidents caused by negligence of safety from taking place in advance.

### BRIEF DESCRIPTION OF THE DRAWINGS

FIG. 1 illustrates a perspective view of a rear side structure of a related art laundry device, schematically;

FIG. 2 illustrates an exploded view of key parts for explaining joining between a power cord assembly and a cabinet of a related art laundry device;

FIG. 3 illustrates a section of key parts for explaining joining between a power cord assembly and a cabinet of a related art laundry device;

FIG. 4 illustrates a perspective view of a rear side structure of a laundry device in accordance with a first preferred embodiment of the present invention, schematically;

FIG. 5 illustrates an exploded view of key parts for explaining joining between a power cord assembly and a cabinet of a laundry device in accordance with a first preferred embodiment of the present invention;

FIG. 6 illustrates a section of key parts for explaining joining between a power cord assembly and a cabinet of a laundry device in accordance with a first preferred embodiment of the present invention;

FIG. 7 illustrates an exploded view of key parts for explaining joining between a power cord assembly and a cabinet of a laundry device in accordance with a second preferred embodiment of the present invention; and

FIG. 8 illustrates a section of key parts for explaining joining between a power cord assembly and a cabinet of a laundry device in accordance with a second preferred embodiment of the present invention.

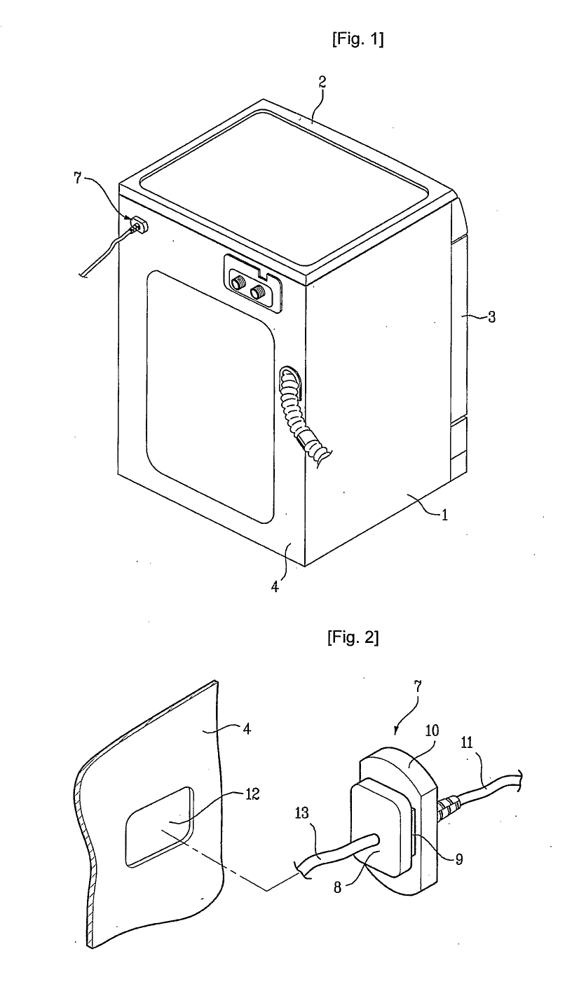

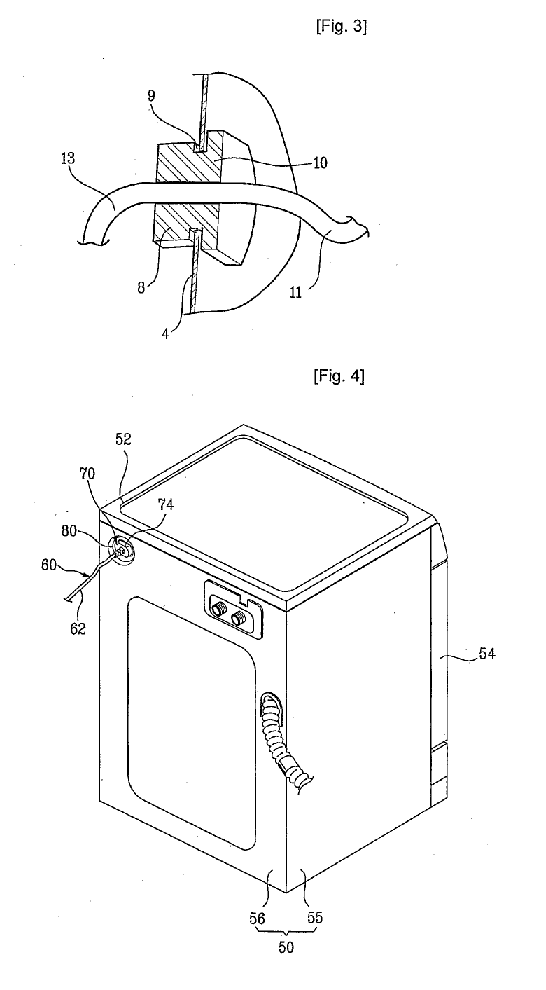

### BEST MODE FOR CARRYING OUT THE INVENTION

Preferred embodiments of the present invention will be described with reference to the attached drawings.

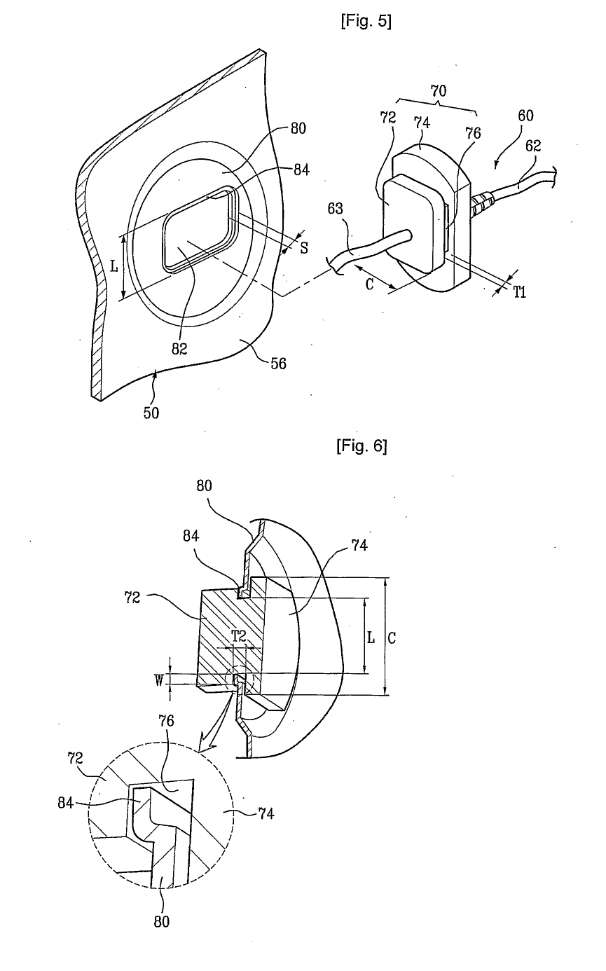

FIG. 4 illustrates a perspective view of a rear side structure of a laundry device in accordance with a first preferred embodiment of the present invention schematically, FIG. 5 illustrates an exploded view of key parts for explaining joining between a power cord assembly and a cabinet of a laundry device in accordance with a first preferred embodiment of the present invention, and FIG. 6 illustrates a section of key parts for explaining joining between a power cord assembly and a cabinet of a laundry device in accordance with a first preferred embodiment of the present invention.

As shown, the laundry device in accordance width a first preferred embodiment of the present invention includes a cabinet 50, a power cord assembly 60, and a depressed portion 84, each of which will be described one by one in more detail.

The cabinet 50 will be described in detail.

The cabinet 50 forms sides and a rear of the laundry device.

There are a top cover 52 secured to a top of the cabinet 50, and a cabinet cover 54 secured to a front of the cabinet 50, and a base (not shown) secured to a bottom of the cabinet 50.

Sidewalls 55, the sides, of the cabinet 50, and a rearwall 56, the rear, of the cabinet 50 are continuous, and there is a hole 82 in one side of the rear wall 56.

Particularly, the hole 82 is formed in a recess 80 recessed toward an inner side of the cabinet 50.

The recess 80 is recessed at a depth enough to prevent a holding member 70 of the power cord assembly 60, which is to be described later, from projecting beyond a plane of the other portion (excluding the recess) of the cabinet 50.

The hole 82 is rectangular. The embodiment of the present invention suggests rectangular which is elongated in a lateral direction.

Next, the power cord assembly 60 will be described in more detail.

The power cord assembly 60 is designed to supply an external power to a control assembly (not shown) and/or various driving units (not shown) of the laundry device.

Referring to FIGS. 5 and 6, the power cord assembly 60 includes electric wires 62, and 63, and a holding member 70.

The electric wires 62, and 63 are cords for supplying the power.

The holding member 70 is at one ends of the electric wires 62, and 63, passed through the hole 82, and secured to the cabinet 50, and has a groove 76 for placing the cabinet 50 therein.

The holding member 70 is formed of an elastic material, and includes a push-in portion 72 and a sealing portion 74.

The push-in portion 72 is configured to be pushed into the cabinet 50 passing through the hole 82, and held at an inner side of the rearwall of the cabinet 50. The push-in portion 72 is rectangular. The embodiment of the present invention suggests the rectangular shape elongated in a lateral direction, for enabling the push-in portion 72 to be pushed into the hole 82 only when the push-in portion 72 is set in a vertical direction.

The sealing portion 74 is formed as one body with the push-in portion 72 with the groove 76 inbetween, and brought into close contact with an outer side of the rearwall when the holding member 70 is secured to the cabinet 50.

The groove 76 has a width T1 greater than a thickness of the cabinet 50, fixed according to a standard.

The depressed portion 84 will be described in detail with reference to FIGS. 5 and 6.

The depressed portion 84 enables the cabinet 50 placed in the groove 76 of the holding member 70 of the power cord assembly 60.

The depressed portion 84 is formed at a portion of the cabinet 50 to be engaged with the groove 76.

Particularly, the depressed portion 84 has an inward or outward step with respect to the cabinet 50. Of course, the depressed portion 84 may have many steps. In this instance, it is preferable that the depressed portion 84 is formed by a forming process.

It is also preferable that the step of the depressed portion 84 has a height T2 substantially identical to a width T1 of the groove 76 enough to press fit the depressed portion 84 to the groove 76.

Along with this, the depressed portion 84 has a width ‘S’ greater than a depth ‘W’ of the groove 76.

Accordingly, once the push-in portion 72 is passed through the hole 82, and turned, the depressed portion 84 is placed in the groove 76. particularly, since the depressed portion 84 is formed of steel, the depressed portion compresses, and holds the holding member 70 of an elastic material.

Referring to FIG. 6, it is preferable that the sealing portion 74 has a lateral width ‘C’ greater than a vertical length ‘L’ of the depressed portion 84, so that the depressed portion 84 is not exposed to an outside of the sealing portion 74 in a state the holding member 70 is held at the cabinet 50.

A process for mounting the power cord assembly 60 to the cabinet 50 will be described with reference to FIG. 5 or 6.

At first, the electric wire 63 is inserted in the cabinet 50 through the hole 82.

Along with this, the holding member 70 of the power cord assembly 60 is mounted to the cabinet 50.

This mounting is made as the push-in portion 72 of the holding member 70 is positioned in a lateral direction thereof (positions the push-in portion 72 to have a shape the same with the hole), and pushes the push-in portion 72 into the hole 82.

Then, once the push-in portion 72 is passed through the hole 82, and positioned on an inner side of the cabinet 50, the holding member 70 is turned by 90° in a clockwise or counter clockwise direction in a state the holding member 70 is pressed further so that the depressed portion 84 is placed in the groove 76 of the holding member 70.

Consequently, the depressed portion 84 in the cabinet 50 is press fit in the groove 76 of the holding member 70.

Moreover, in this instance, opposite surfaces of the push-in portion 72 and the sealing portion 74 of the holding member 70 are brought into close contact with the inner, and outer surfaces of the cabinet 50, respectively.

Accordingly, the hole 82 is invisible from an outside of the cabinet 50, and no water can infiltrate into the cabinet 50 from an outside of the cabinet 50. Especially, since the depressed portion 84 and the groove 76 are also brought into close contact with each other, infiltration of water through the hole 82 is prevented.

Moreover, since the holding member 70 maintains a state securely fixed to the cabinet 50 even if the laundry device shakes, the falling off of the power cord assembly 60 is prevented, to resolve the hazard of accident caused by negligence of safety.

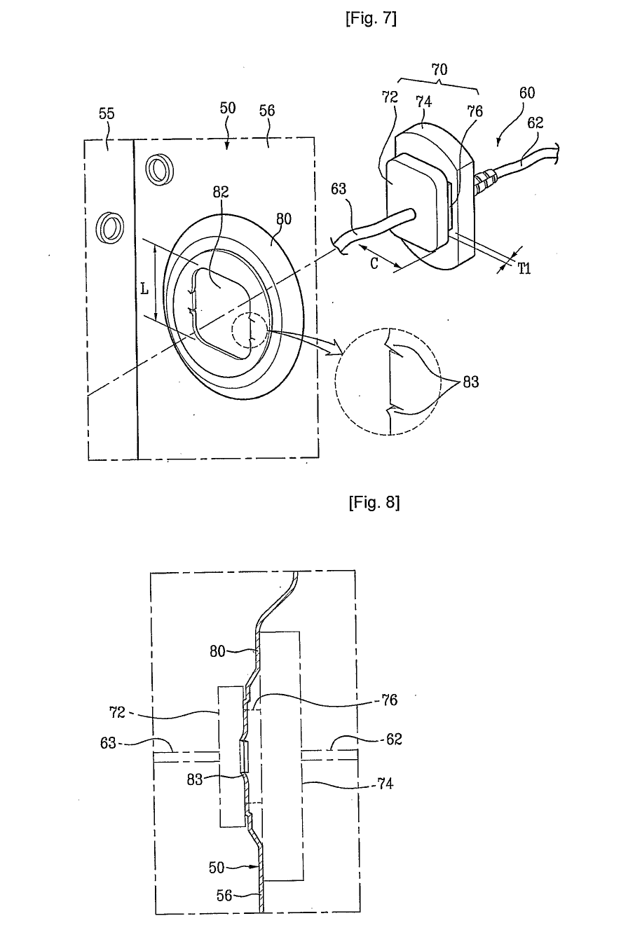

In the meantime, FIGS. 7 and 8 each illustrates a laundry device in accordance with a second preferred embodiment of the present invention.

The laundry device in accordance with a second preferred embodiment of the present invention is characterized in that the laundry device includes a holding portion 83.

That is, instead of the depressed portion 84 in the first embodiment, the laundry device in the second embodiment includes at least one holding portion 83 so that the power cord assembly 60 does not move, such as turning, in a state the power cord assembly 60 is mounted to the cabinet 50.

The holding portion 83 will be described in more detail width reference to FIGS. 7 and 8.

There are a plurality of the holding portions 83 each projected toward an inner, or outer side of the cabinet 50 (the same or opposite direction of recess of the recess 80)

It is preferable that the holding portion 83 has a projection height enough to hold the groove 76 as a tip of the holding portion 83 is engaged with an inside surface of the groove 76 when a portion of the cabinet 50 having the hole 82 formed therein is placed in the groove 76 of the holding member 70.

The holding portion 83 may be formed in a variety of methods.

The laundry device in accordance with a second preferred embodiment of the present invention suggests to form the holding portion 83 by cutting a portion of an edge of a long side (or short side) of the hole 82 in the cabinet 50, and bending a corner of the cut portion by a predetermined angle to slope the corner.

Particularly, though the corner of the holding portion 83 may be bent in a clockwise direction, or counter clockwise direction, it is preferable that adjacent to corners of the holding portion 83 are in directions opposite to each other, for preventing the power cord assembly from turning both in the clockwise or counter clockwise direction. That is, even if the power cord assembly 60 tends to turn in the clockwise direction or counter clockwise direction, at least some of the holding portions 83 have the corners in a direction opposite to the direction of turning of the power cord assembly 60, turning of the power cord assembly 60 is prevented.

The holding portion 83 may be projected toward the inner, or outer side of the cabinet 50. Moreover, some of the holding portions 83 may be projected toward the inner side of the cabinet 50, while rest of the holding portions 83 may be projected toward the outer side of the cabinet 50.

A process for mounting the power cord assembly 60 in accordance with the second preferred embodiment of the present invention to the cabinet 50 is identical to the first embodiment substantially, which will be described.

At first, after inserting the electric wire 63 in the cabinet 50 through the hole 82, the holding member 70 of the power cord assembly 60 is mounted to the cabinet 50.

This mounting is made as the push-in portion 72 of the holding member 70 is positioned in a lateral direction thereof (positions the push-in portion 72 to have a shape the same with the hole), and pushes the push-in portion 72 into the hole 82.

Then, once the push-in portion 72 is passed through the hole 82, and positioned on an inner side of the cabinet 50, the holding member 70 is pressed further so that the cabinet 50 is placed in the groove 76 of the holding member 70, and the holding portions 83 are engaged with an inside wall of the groove 76.

Under this state, the holding member 70 is turned by 90° in a clockwise or counter clockwise direction and removes application of pressure, so that the holding member 70 restores its original shape by its restoring capability, so that the holding member 70 is held in a state the tips of the holding portions 83 are engaged with the inside wall of the groove 76.

Moreover, in this instance, the push-in portion 72 and the sealing portion 74 of the holding member 70 are brought into close contact with the inner, and outer surfaces of the cabinet 50, respectively.

Accordingly, the hole 82 is invisible from an outside of the cabinet 50, and no water can infiltrate into the cabinet 50 through the hole 82 from an outside of the cabinet 50.

Moreover, the turning of the holding member 70 is prevented even if the holding member 70 of the power cord assembly 60 moves due to movement of the laundry device.

This is because the holding portions 83 are held in the groove 76, and the tips of the holding portions 83 are sloped, and projected in the clockwise or counter clockwise direction.

According to this, the falling off of the power cord assembly 60 from the hole is prevented, to resolve the hazard of accident caused by negligence of safety.

In the meantime, a structure for joining a power cord assembly of a laundry device in accordance with the present invention can not be embodied only with the first, or second embodiment.

That is, a series of structure of the first embodiment may be combined with a structure of the second embodiment.

For an example, the holding portion 83 of the second embodiment may be formed in addition to the depressed portion 84 of the first embodiment.

Thus, there may be many variations and modifications to a structure for joining the power cord assembly of the present invention according to technical aspects of the present invention.

### INDUSTRIAL APPLICABILITY

Since the laundry device in accordance with the first, or second preferred embodiment of the present invention permits secure fixing of the power cord assembly to the cabinet, the present invention is applicable to industries.

1. A laundry device comprising:
a cabinet having a hole;
a power cord assembly having electric wires, and a holding member at one ends of the electric wires with a groove at a circumferential surface for placing the cabinet therein, for passing through the hole, and securing to the cabinet; and
a depressed portion at a portion of the cabinet where the groove is to be placed therein, for press fitting in the groove.

2. The laundry device as claimed in claim 1, further comprising a recess recessed toward an inner side of the cabinet compared to the other portion of the cabinet, at a portion having the hole in the cabinet formed therein

3. The laundry device as claimed in claim 2, wherein the recess has a depth enough to prevent a rear surface of the holding member from projecting beyond the other portion of the cabinet.

4. The laundry device as claimed in claim 1, wherein the holding member includes;
a push-in portion for being pushed into the cabinet passing through the hole, and held at an inner side of the rearwall of the cabinet, and
a sealing portion formed as one body with the push-in portion with the groove inbetween, for being brought into close contact with an outer side of the rearwall.

5. The laundry device as claimed in claim 4, wherein the push-in portion and the hole are rectangular.

6. The laundry device as claimed in claim 1, wherein the groove has a width greater than a thickness of the cabinet.

7. The laundry device as claimed in claim 1, wherein the depressed portion has a step toward an inner or cuter side of the cabinet.

8. The laundry device as claimed in claim 1, wherein the holding member is formed of an elastic material.

9. The laundry device as claimed in claim 1, wherein the depressed portion further includes at least one holding portion.

10. The laundry device as claimed in claim 9, wherein the holding portion is projected toward the inner side of the cabinet.

11. A laundry device comprising:
a cabinet having a hole;
a power cord assembly having electric wires, and a holding member at one ends of the electric wires with a groove at a circumferential surface for placing the cabinet therein, for passing through the hole, and securing to the cabinet; and
at least holding portion projected from a portion of the cabinet where the groove is to be placed therein to an inner or outer side of the cabinet.

12. The laundry device as claimed in claim 11, further comprising a recess recessed toward an inner side of the cabinet compared to the other portion of the cabinet, at a portion having the hole in the cabinet formed therein

13. The laundry device as claimed in claim 12, wherein the recess has a depth enough to prevent a rear surface of the holding member from projecting beyond the other portion of the cabinet.

14. The laundry device as claimed in claim 11, wherein the holding member includes;
a push-in portion for being pushed into the cabinet passing through the hole, and
held at an inner side of the rearwall of the cabinet, and a sealing portion formed as one body with the push-in portion with the groove inbetween, for being brought into close contact with an outer side of the rearwall.

15. The laundry device as claimed in claim 14, wherein the push-in portion and the hole are rectangular.

16. The laundry device as claimed in claim 14, wherein the holding member is formed of an elastic material.

17. The laundry device as claimed in claim 11, wherein the groove has a width greater than a thickness of the cabinet.

18. The laundry device as claimed in claim 11, wherein the holding portion includes a portion of the portion where the groove is to be placed therein cut, and bent at a tip of the cut toward the inner or outer side of the cabinet by a predetermined angle to slope the tip.

19. The laundry device as claimed in claim 18, wherein there are a plurality of holding portions, and the holding portions are projected in the same direction.

20. The laundry device as claimed in claim 19, wherein the tips of adjacent holding portions are projected in directions opposite to each other.

21. The laundry device as claimed in claim 18, wherein there are a plurality of holding portions, and some of the holding portions are projected in a direction opposite to a direction rest of the holding projections are projected.
